(19) United States
(12) Patent Application Publication
(10) Pub. No.: US 2026/0339098 A1
(43) Pub. Date: Oct. 29, 2026

(54) OPTICAL SYSTEM AND DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventor: YU-MEI KUO

(21) Appl. No.: 18/880,620

(22) PCT Filed: Jun. 14, 2024
(86) PCT No.: PCT/CN2024/099446

§ 371 Date: Jan. 2, 2025

(51) Int. Cl. G02B 27/01; G02B 27/09; G02B 27/14; G02B 27/28

(52) U.S. Cl. CPC G02B 27/0172; G02B 27/0955; G02B 27/14; G02B 27/28; G02B 2027/0178

(57) ABSTRACT

An optical system includes a first lens including a light incidence surface and a first light-guiding surface connected to each other, a second lens on a side of the first lens having the first light-guiding surface, a reflective polarizer on the side of the first lens away from the second lens, a first quarter wave plate between the first lens and the second lens, and a selective reflector on a side of the second lens away from the first lens. The first light-guiding surface includes a first area and a second area connected to each other. The first area is configured for total internal reflection of image light from the light incidence surface, and the second area is configured to transmit the image light. The selective reflector is configured to reflect at least a portion of the image light towards the reflective polarizer. The above optical system can display AR images and is conducive to product thinning. A display device is also provided.

### FIELD

The subject matter herein generally relates to display technology, and particularly relates to an optical system and a display device including the optical system.

### BACKGROUND

A conventional Augmented Reality (AR) glasses is based on a Birdbath optical scheme to display AR images.

As shown in FIG. 8, an internal optical system of the conventional AR glasses includes a display 401, a beam splitter 402, and a lens 403. A surface of the display 401 emitting image light forms a 45° angle with the beam splitter 402. The beam splitter 402 reflects a portion of the image light onto the lens 403. A coating 404 is formed on one side of the lens 403 away from the beam splitter 402 to reflect a portion of the image light back onto the beam splitter 402. The portion of the image light transmits through the beam splitter 402 to the human eyes 500.

Due to the Birdbath optical scheme shown in FIG. 1, it is difficult to increase a view aperture V or shorten a view distance D of the conventional AR glasses, resulting in a thicker (about 25 mm or more) module of the AR glasses. In addition, the traditional AR glasses is not possible to make the user's eyes visible from outside, and only dark gray lenses or reflective lights can be observed from the outside.

### SUMMARY

A first aspect of the present disclosure provides an optical system including: a first lens comprising a light incidence surface and a first light-guiding surface connected to each other, the first light-guiding surface comprising a first area and a second area connected to each other, the first area being configured for total internal reflection of image light from the light incidence surface, and the second area being configured to transmit the image light; a second lens on a side of the first lens having the first light-guiding surface; a reflective polarizer on a side of the first lens away from the second lens; a first quarter wave plate between the first lens and the second lens; and a selective reflector on a side of the second lens away from the first lens, the selective reflector being configured to reflect at least a portion of the image light towards the reflective polarizer.

A second aspect of the present disclosure provides a display device including: a micro-display configured to emit image light; and an optical system on a light path of the image light and being configured to modulate ambient light and the image light jointly to display AR images, the optical system comprising: a first lens comprising a light incidence surface and a first light-guiding surface connected to each other, the first light-guiding surface comprising a first area and a second area connected to each other, the first area being configured for total internal reflection of image light from the light incidence surface, and the second area being configured to transmit the image light; a second lens on a side of the first lens having the first light-guiding surface; a reflective polarizer on a side of the first lens away from the second lens; a first quarter wave plate between the first lens and the second lens; and a selective reflector on a side of the second lens away from the first lens, the selective reflector being configured to reflect at least a portion of the image light towards the reflective polarizer.

The above optical system includes a first lens, a second lens, a reflective polarizer, a first quarter wave plate, and a selective reflector. The first lens and the second lens are used to jointly focus image light and ambient light onto the human eyes. The first quarter wave plate is used to phase delay the image light to change its polarization direction. The selective reflector is used to reflect at least a portion of the image light towards the reflective polarizer. The first light-guiding surface of the first lens includes a first area for total internal reflection of the image light. By placing the first lens, second lens, and first quarter wave plate between the reflective polarizer and the selective reflector, changing a polarization state of the image light by the first quarter wave plate, and the total internal reflection of the image light in the first area, the image light from the light incidence surface of the first lens can propagate back and forth in the optical system and be projected onto the human eyes. This is conducive for extending an optical path of the image light while maintaining a lightness of the optical system.

Moreover, by setting the selective reflector, the ambient light from outside of the optical system can also be partially transmitted from the selective reflector into the optical system and focused on the human eyes. Users can observe AR images based on the ambient light and the image light. When users wear the display device including the optical system, the wearer's eyes can be observed from the outside due to a transparency of the optical system.

### BRIEF DESCRIPTION OF THE DRAWINGS

FIG. 1 shows a display device according to an embodiment of the present disclosure.

FIG. 2 shows an optical system and a micro-display according to an embodiment of the present disclosure.

FIG. 3 is an exploded view of the optical system and micro display in FIG. 2.

FIG. 4 shows the optical system and the micro display according to a modified embodiment of the present disclosure.

FIG. 5 is an optical diagram of the optical system in FIG. 2 generated by simulation software.

FIG. 6 is a light-intensity distribution diagram of the optical system in FIG. 2 generated by a simulation software.

FIG. 7 is a light distribution diagram of the optical system in FIG. 2 generated by a simulation software.

FIG. 8 shows an optical system using the Birdbath optical scheme in the art.

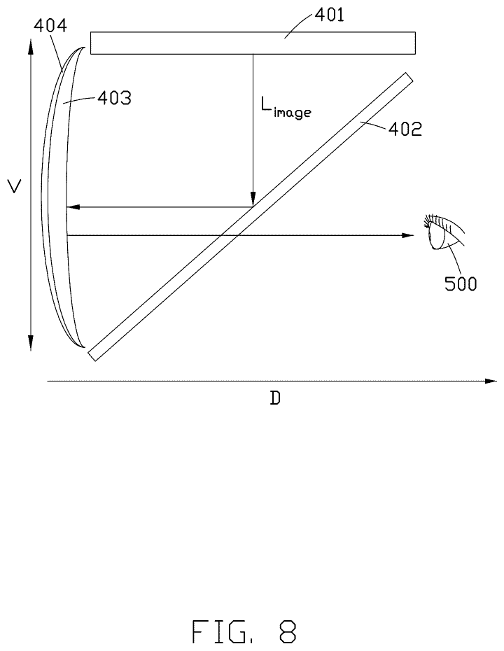

DESCRIPTION OF SYMBOLS OF MAIN COMPONENTS

| | |
|---|---|
| Display device | 100 |
| Optical system | 1 |
| First lens | 10 |
| Light incidence surface | 11 |
| First light-guiding surface | 12 |
| First area | 121 |
| Second area | 122 |
| Second light-guiding surface | 13 |
| Bottum surface | 14 |
| Second lens | 20 |
| First surface | 21 |
| Second surface | 22 |
| Reflective polarizer | 30 |
| First quarter-wave plate | 40 |
| Selective reflector | 50 |
| Second quarter-wave plate | 60 |
| First linear polarizer | 70 |
| Second linear polarizer | 80 |
| First optical adhesive layer | 91 |
| Second optical adhesive layer | 92 |
| Third optical adhesive layer | 93 |
| Fourth optical adhesive layer | 94 |
| Micro-display | 2 |
| Display surface | 201 |
| Glass body | 3 |
| Optic axis | L1, L2 |
| Image light | L_{image}, L01, L02, |
| | L03, L04, L' |
| Ambient light | L05 |
| User's eyes | 200, 500 |
| Display | 301/401 |
| Optical system | 302 |
| Exit pupil position | 303 |
| Receiver | 304 |
| Display | 401 |
| Beam splitter | 402 |
| Lens | 403 |
| Coating | 404 |
| View aperture | V |
| View distance | D |

The following specific embodiments will further illustrate the present disclosure in conjunction with the above drawings.

### DETAILED DESCRIPTION

In order to have a clearer understanding of the purposes, features, and advantages of the present disclosure above, a detailed description of the present disclosure will be provided below in conjunction with the accompanying drawings and specific embodiments. It should be noted that, without conflict, the embodiments of this disclosure and the features in the embodiments can be combined with each other.

Many specific details are elaborated in the following description to facilitate a full understanding of the present disclosure. The described embodiments are only a part of the embodiments of the present disclosure, not all of them. Based on the embodiments in this disclosure, all other embodiments obtained by ordinary skilled person in the art without creative labor fall within the scope of the protection of this disclosure.

Unless otherwise defined, all technical and scientific terms used in this article have the same meanings as those commonly understood by those skilled in the technical field of this disclosure. The terms used in the specification of this disclosure are only for the purpose of describing specific embodiments and are not intended to limit this disclosure.

The present disclosure provides an optical system and a display device including the optical system. The display device can be an AR glasses, a head mounted display, etc. The optical system includes two lenses to replace a traditional Birdbath optical scheme, which is conducive for lightness and thinness of the optical system and the display device. Moreover, the optical system can simultaneously modulate ambient light and image light to display AR images.

The following embodiments illustrate the display device as an AR glasses.

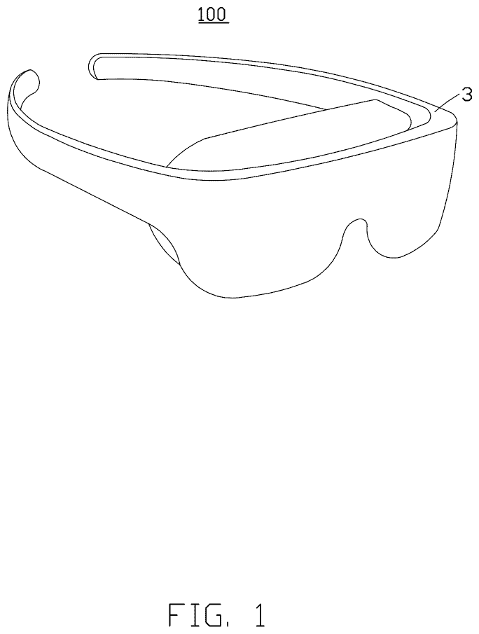

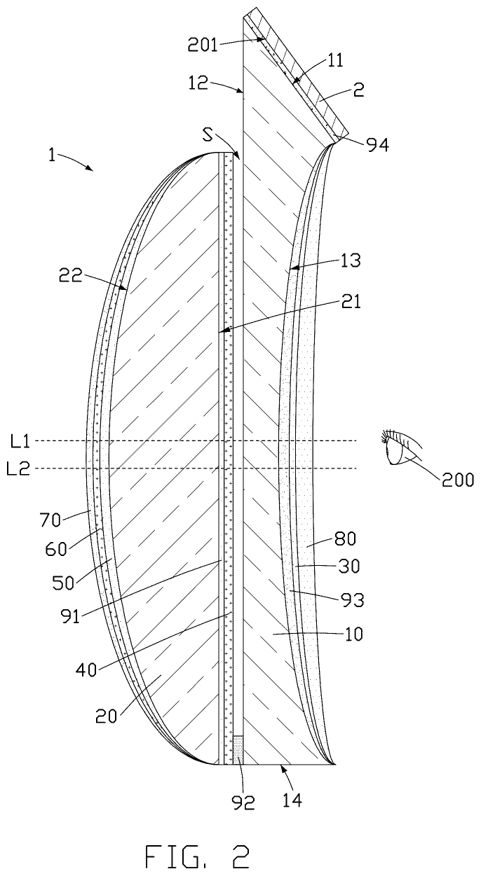

As shown in FIG. 1 and FIG. 2, in this embodiment, the display device 100 includes an optical system 1, a micro-display 2, and a glasses body 3. The optical system 1 and the micro-display 2 are inside the eyeglass body 3. The glasses body 3 can also be equipped with a control circuit (not shown in the figure) that is electrically connected to the micro-display 2 to control the micro-display 2 emitting image light. The optical system 1 is on an optical path of the image light emitted by the micro display 2 and is used to modulate the image light and project modulated image light onto the user's eyes 200. The micro-display 2 can be a micro light-emitting diode display, an organic light-emitting diode display, etc.

As shown in FIG. 2, in this embodiment, the optical system 1 includes a first lens 10, a second lens 20, a reflective polarizer 30, a first quarter wave plate 40, a selective reflector 50, a second quarter wave plate 60, a first linear polarizer 70, and a second linear polarizer 80. In this embodiment, an optical axis L1 of the first lens 10 is parallel to and does not coincide with an optical axis L2 of the second lens 20. The first linear polarizer 70, the second quarter wave plate 60, the selective reflector 50, the second lens 20, the first quarter wave plate 40, the first lens 10, the reflective polarizer 30, and the second linear polarizer 80 are arranged sequentially along the optical axis L1 and the optical axis L2.

In this embodiment, the first lens 10 is a flat concave lens. The first lens 10 includes a light incidence surface 11, a first light-guiding surface 12, a second light-guiding surface 13, and a bottom surface 14. The light incidence surface 11, the first light-guiding surface 12, the bottom surface 14, and the second light-guiding surface 13 are sequentially connected to form the first lens 10. The first light-guiding surface 12 and the second light-guiding surface 13 are opposite to each other and are perpendicular to the optical axis L1. The light incidence surface 11 has a non-zero angle with the optical axis L1. The bottom surface 14 is parallel to the optical axis L1. The first light-guiding surface 12 is a flat surface and faces the second lens 20. The second light-guiding surface 13 concave towards the first light-guiding surface 12 and faces the reflective polarizer 30.

In this embodiment, the second lens 20 is a planar convex lens. The second lens 20 includes a first surface 21 and a second surface 22, and the first surface 21 is enclosed with the second surface 22 to form the second lens 20. The first surface 21 is a flat surface and faces the first lens 10. The second surface 22 is a convex surface that protrudes in a direction away from the first surface 21.

In this embodiment, the optical system 1 further includes four optical adhesive layers, namely: a first optical adhesive layer 91, a second optical adhesive layer 92, a third optical adhesive layer 93, and a fourth optical adhesive layer 94. The first optical adhesive layer 91 is between the second lens 20 and the first quarter wave plate 40 and is used to paste and fix the first quarter wave plate 40 onto the first surface 21 of the second lens 20. The first quarter wave plate 40 has a planar structure that is essentially the same as the first surface 21, so that an orthographic projection of the first quarter wave plate 40 on the first surface 21 completely coincides with the first surface 21. The first optical adhesive layer 91 completely fills a space between the first quarter wave plate 40 and the first surface 21.

The second optical adhesive layer 92 is between the first quarter wave plate 40 and the first lens 10 and is used to paste and fix a surface of the first quarter wave plate 40 away from the second lens 20 and the first light-guiding surface 12 of the first lens 10. The second optical adhesive layer 92 is pasted on a portion of the first quarter wave plate 40 and the first light-guiding surface 12. That is, a space between the first quarter wave plate 40 and the first lens 10 is partially filled with the second optical adhesive layer 92, and the other portion of the space forms an air gap S. In this embodiment, the second optical adhesive layer 92 is attached to a portion of the second light-guiding surface 13 near the bottom surface 14, and an area of the second light-guiding surface 13 where the second optical adhesive layer 92 is not attached is much larger than an area of the second light-guiding surface 13 where the second optical adhesive layer 92 is attached.

The third optical adhesive layer 93 is between the second light-guiding surface 13 of the first lens 10 and the reflective polarizer 30. The third optical adhesive layer 93 is used to paste and fix the reflective polarizer 30 onto the second light-guiding surface 13. The third optical adhesive layer 93 fills a space between the second light-guiding surface 13 and the reflective polarizer 30. An orthographic projection of the reflective polarizer 30 on the second light-guiding surface 13 coincides with the second light-guiding surface 13.

The fourth optical adhesive layer 94 is between the light incidence surface 11 of the first lens 10 and the micro-display 2. The micro-display 2 has a display surface 201 for emitting image light. The fourth optical adhesive layer 94 is used to stick and fix the light surface 11 and the display surface 201. The fourth optical adhesive layer 94 fills a space between the optical surface 11 and the display surface 201. An orthographic projection of the display surface 201 on the incident surface 11 is within the incident surface 11, allowing the incident surface 11 to receive as much image light as possible from the display surface 201, thereby improving light utilization efficiency.

In this embodiment, the reflector 50 is formed on the second surface 22 of the second lens 20 through coating, and completely covers the second surface 22. The second quarter wave plate 60 is a thin-film like structure attached to a surface of the selective reflector 50 away from the second lens 20. The second quarter wave plate 60 completely covers the surface of the selective reflector 50 away from the second lens 20. The first linear polarizer 70 is a thin film like structure attached to the surface of the second quarter wave plate 60 away from the second lens 20, and the first linear polarizer 70 completely covers the surface of the second quarter wave plate 60 away from the second lens 20. The second linear polarizer 80 is a thin-film like structure attached to the surface of the reflective polarizer 30 away from the first lens 10, and the second linear polarizer 80 completely covers the surface of the reflective polarizer 30 away from the first lens 10 away from the first lens 10.

In at least one modification embodiment of this disclosure, an anti-reflective film can be coated on a surface of the first linear polarizer 70 away from the second lens 20 and a surface of the second linear polarizer 80 away from the first lens 10 to reduce light loss.

As shown in FIG. 2, in the optical system 1 of this embodiment, each optical element and optical film (including the first lens 10, the second lens 20, the reflective polarizer 30, the first quarter wave plate 40, the selective reflector 50, the second quarter wave plate 60, the first linear polarizer 70, and the second linear polarizer 80) are fixed together. Moreover, the optical system 1 and the micro-display 2 are also fixed to each other. When the display device 100 is working, a position relationship of the optical components and the optical films in the optical system 1 remains unchanged, and a relative position relationship between the optical system 1 and the micro-display 2 also remains unchanged.

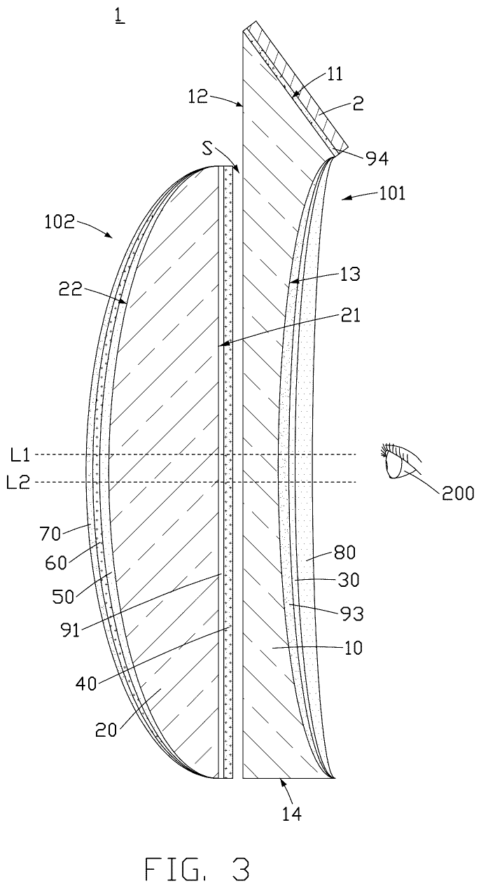

As shown in FIG. 3, in at least one modified embodiment of this disclosure, the optical system 1 may not include the second optical adhesive layer 92. In this modified embodiment, the optical system 1 includes a first lens assembly 101 and a second lens assembly 102. The first lens assembly 101 includes the first lens 10, the reflective polarizer 30, the second linear polarizer 80, the third optical adhesive layer 93, and the fourth optical adhesive layer 94. The second lens assembly 102 includes the second lens 20, the first quarter wave plate 40, the selective reflector 50, the second quarter wave plate 60, and the first linear polarizer 70. Structures in the first lens assembly 101 are fixed together and their position relationship remain unchanged. Structures in the second lens assembly 102 are fixed together and their position relationship remain unchanged. The first lens assembly 101 and the second lens assembly 102 are independently of each other.

In this modified embodiment, the display device 100 may further include a driving structure (not shown, such as a voice coil motor, a screw motor, etc.) connecting the first lens assembly 101 and/or the second lens assembly 102 to drive the first lens assembly 101 and/or the second lens assembly 102 to move along the optical axis L1, so that the first lens assembly 101 and the second lens assembly 102 can generate relative displacement along the optical axis L1, thereby achieving the optical system 1 focusing to adapt to a situation where the wearer is nearsighted. An focus position of the image light changes with a myopia degree of the wearer, so that the wearer can observe a clear image.

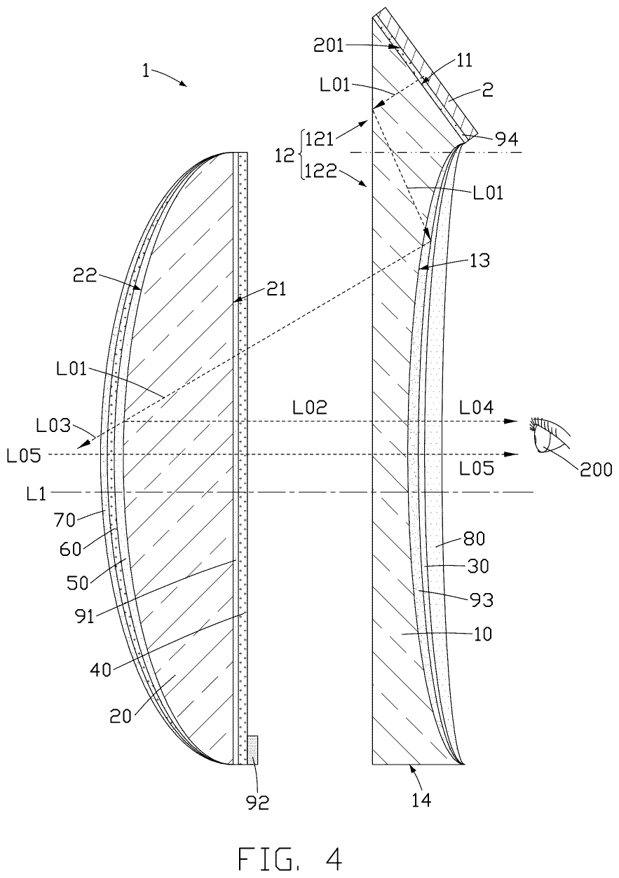

As shown in FIG. 4, in this embodiment, the light incidence surface 11 is not parallel to the bottom surface 14. That is, the light incidence surface 11 has non-zero angles with the bottom surface 14 and the optical axis L1, respectively. The light incidence surface 11 tilts towards the second lens 20. That is, an area of a orthographic projection of the second light-guiding surface 13 of the first lens 10 on the first light-guiding surface 12 is smaller than an area of the first light-guiding surface 12. In other words, the angle θ between the light incidence surface 11 and the first light guiding surface 12 is an acute angle. In this embodiment, the angle θ between the light incidence surface 11 and the first light guiding surface 12 is between 10°-70° (including endpoint values). Therefore, the image light incident from the incident surface 11 has a specific incidence angle.

In this embodiment, the first light-guiding surface 12 of the first lens 10 includes a first area 121 and a second area 122. The first area 121 and the second area 122 are connected to each other to form the first light-guiding surface 12. The first area 121 is connected between the light incidence surface 11 and the second area 122, and the second area 122 is connected between the first area 121 and the bottom surface 14. That is, take FIG. 4 as a reference, the first area 121 is an upper area of the first light-guiding surface 12, and the second area 122 is a lower area of the first light-guiding surface 12.

In this embodiment, the first area 121 is smaller than the second area 122. An orthographic projection of the second lens 20 onto the first lens 10 is within the second area 122. The first area 121 is used for total internal reflection of the image light, and the second area 122 is used for transmitting the image light. An orthographic projection of the micro-display 2 on the first light-guiding surface 12 is within the first area 121, which is conducive to guiding the image light to the first area 121 for total internal reflection.

In this embodiment, the micro-display 2 is used to emit the image light through the display surface 201. The incident surface 11 of the first lens 10 is used to receive and transmit the image light. The first area 121 of the first light-guiding surface 12 is used for total internal reflection of the received image light, and the second area 122 of the first light-guiding surface 12 is used for transmitting the image light. The reflective polarizer 30 is used to transmit the image light with specific polarization states and reflect the image light with other polarization states. The first quarter wave plate 40 and the second quarter wave plate 60 are used to apply a quarter phase delay to the image light received. The selective reflector 50 is a beam splitter for partial transmitting and partial reflecting of the image light received. In this embodiment, the reflector 50 is selected to reflect 40% of the image light and transmit 60% of the image light. The first linear polarizer 70 and the second linear polarizer 80 each have specific transmission axes for transmitting the image light parallel to the polarization axis and absorbing the image light that is not parallel to the transmission axis.

The following is a description of a working process of the optical system 1 and the micro-display 2 of the present embodiment in conjunction with FIG. 4:

Under the control of the control circuit (not shown), the display surface 201 of the micro-display 2 emits the image light L01 that can display specific images. The image light L01 is linearly polarized and has an S-polarized state. Due to the acute angle θ between the light incidence surface 11 and the first light-guiding surface 12, the image light L01 from the micro-display 2 is transmitted through the light incidence surface 11 and propagates towards the first light-guiding surface 12 in the first lens 10.

In this embodiment, the first lens 10 is made of glass material. A left medium of the first lens 10 is air, and a refractive index difference between air and glass is large (air refractive index is 1, glass refractive index is 1.5). By setting the angle θ and a specific value of an emission angle of the image light L01 emitted by the micro-display 2, the image light L01 can be incident as much as possible to the first area 121 of the first light-guiding surface 12, and total internal reflection occurs in the first area 121.

The image light L01 reflected from the first area 121 of the first light-guiding surface 12 propagates towards the second light-guiding surface 13 in the first lens 10, and sequentially transmits from the second light-guiding surface 13 and the third optical adhesive layer 93. The image light L01 transmitted from the third optical adhesive layer 93 incidents onto the reflective polarizer 30.

The image light L01 transmitted from the third optical adhesive layer 93 has an S-polarization state. The reflective polarizer 30 is used to reflect image light with an S-polarization state and to transmit image light with a P-polarization state. Therefore, the image light L01 transmits from the third optical adhesive layer 93 to the reflective polarizer 30 is reflected by the reflective polarizer 30.

The image light L01 reflected by the polarizer 30 transmits through the third optical adhesive layer 93, enters the first lens 10 again, and propagates in the first lens 10 towards the second area 122 of the first light-guiding surface 12. The reflective polarizer 30 changes a propagation angle of the image light L01 when reflects the image light L01, which breaks a total internal reflection condition. Therefore, the image light L01 incident on the second area 122 of the first light-guiding surface 12 will be transmitted out by the second area 122.

The image light L01 transmitted by the second area 122 incidents through the air gap S onto the first quarter wave plate 40. The first quarter wave plate 40 converts the image light L10 from the first lens 10 and in a S-polarization state into left circularly polarized light and transmits the image light L0.

The image light L01 transmitted from the first quarter wave plate 40 propagates in the second lens 20. When the image light L01 incidents on the selective reflector 50, 40% of the image light L01 is reflected back into the second lens 20 by the selective reflector 50, and the remaining 60% of the image light L01 is transmitted by the selective reflector 50. The 40% of the image light L01 reflected by the selective reflector 50 is defined as an image light L02, and the 60% of the image light L01 transmitted by the selective reflector 50 is defined as an image light L03.

A phase of the image light L01 reflected by the selective reflector 50 is rotated by 180°, therefore the image light L02 reflected by the selective reflector 50 is right circularly polarized light. The image light L02 transmits from the second lens 20 and incidents onto the first quarter wave plate 40. The first quarter wave plate 40 converts the image light L02 into an image light L04 with P-polarization state and transmits the image light L04.

The image light L04 sequentially transmits from the first lens 10, the third optical adhesive layer 93, and the reflective polarizer 30 before being incident onto the second linear polarizer 80. A polarization axis of the image light L04 is parallel to a polarization axis of the second linear polarizer 80, so that the image light L04 transmits from the second linear polarizer 80 and propagates in a direction away from the first lens 10. When the user wears the display device 100, the human eye 200 is on a side of the second linear polarizer 80 away from the first lens 10. Therefore, the image light L04 projected by the second linear polarizer 80 ultimately enters the human eye 200, and the user can observe the image formed based on the image light L04.

On the other hand, the image light L03 transmitted by the selective reflector 50 is left circularly polarized light. When the image light L03 incidents on the second quarter wave plate 60, the second quarter wave plate 60 converts the image light L03 into linearly polarized light and transmits the image light L03. A polarization axis of the image light L03 transmitted from the second quarter wave plate 60 is perpendicular to a penetration axis of the first linear polarizer 70, so that the first linear polarizer 70 absorbs the image light L03 received.

In addition, ambient light L05 outside the display device 100 will incident into the optical system 1. The ambient light L05 is natural light, which includes beams with various polarization states. A part of the ambient light L05 with a polarization axis parallel to a transmission axis of the first linear polarizer 70 can be transmitted from the first linear polarizer 70 and enter the optical system 1.

The ambient light L05 from the first linear polarizer 70 is transformed into right circularly polarized light after passing through the second quarter wave plate 60 and the selective reflector 50 sequentially. The ambient light L05 transmitted from the second lens 20 is converted into light with P-polarization state by the first quarter wave plate 40 when passing through the first quarter wave plate 40. The ambient light L05 transmitted from the first quarter wave plate 40 sequentially transmit through the first lens 10, the reflective polarizer 30, and the second linear polarizer 80 to enter the human eye 200.

Therefore, the optical system 1 of this embodiment allows the human eye 200 to simultaneously observe the real environment presented based on the ambient light L05 and the image presented based on the image light L04. That is, the optical system 1 of this embodiment enables the human eye 200 to observe AR images.

The optical system 1 of the present embodiment includes a first lens 10, a second lens 20, a reflective polarizer 30, a first quarter wave plate 40, and a selective reflector 50. The first lens 10 and the second lens 20 are used to jointly focus the image light and the ambient light to the human eye 200. The first quarter wave plate 40 is used to phase delay the image light received to change the polarization direction of the image light. The selective reflector 50 is used to reflect at least a portion of the image light received towards the reflective polarizer 30. The first light-guiding surface 12 of the first lens 10 includes a first area 121 for total internal reflection of the image light. By setting the first lens 10, the second lens 20, and the first quarter wave plate 40 between the reflective polarizer 30 and the selective reflector 50, setting the first quarter wave plate 40 to change the polarization state of the image light, and setting the total internal reflection of the image light in the first area 121, the image light from the incident surface 11 of the first lens 10 can be projected back and forth into the human eye 200 in the optical system 1, which is beneficial for extending the optical path of the image light while maintaining a lightness of the optical system 1.

In the present embodiment, the first lens 10 is a flat concave lens, the second lens 20 is a flat convex lens, and the first lens 10 is arranged side by side with the second lens 20 (i.e., the optical axes of the first lens 10 and the second lens 20 are parallel to each other), resulting in a significant reduction in a thickness (a size along the optical axis direction of the first lens 10 and the second lens 20) of the entire optical system 1. In at least one embodiment of the present disclosure, the thickness of the optical system 1 can be reduced to 13 mm. Compared to the traditional 25 mm optical system, the optical system 1 of the present disclosure achieves a thickness reduction of nearly 50%.

In addition, by setting the selective reflector 50, the ambient light outside the optical system 1 can also partially transmit through the selective reflector 50 into the optical system 1 and be focused on the human eye. Users can observe AR images based on both the ambient light and the image light simultaneously. When the user wears the display device 100 including the optical system 1, due to a transparency of the optical system 1, the human eyes can be observed from the outside.

Furthermore, in the present embodiment, the first light-guiding surface 12 of the first lens 10 includes a first area 121 and a second area 122. The first area 121 is connected between the light incidence surface 11 and the second area 122, and the second area 122 is connected between the first area 121 and the bottom surface 14. The orthographic projections of the second lens 20 and the first quarter wave plate 40 on the first lens 10 are within the second area 122. That is, take the orientation in FIG. 4 as the reference, a lower edge of the first lens 10 is flush with a lower edge of the second lens 20, while an upper edge of the first lens 10 is not flush with an upper edge of the second lens 20. The upper edge of the first lens 10 is higher than the upper edge of the second lens 20, and an area where the first lens 10 is higher than the second lens 20 is the first area 121.

When the optical system 1 of the present embodiment is applied to the display device 100, a size of a view aperture of the display device 100 is determined by a size of the first lens 10. Due to the total internal reflection of the image light on the first area 121, no image light is transmitted towards the second lens 20 within the first area 121. If the upper edge of the first lens 10 is flush with the upper edge of the second lens 20 (the orthographic projection of the second lens 20 on the first lens 10 coincides with the first light-guiding surface 12), the first area 121 will also fall within the view aperture of the display device 100, wherein it will be observed from the outside that there is an area of the display device 100 without image display, which affects an appearance. Therefore, the present embodiment excludes the first area 121 from the view aperture of the display device 100 by setting the upper edge of the first lens 10 higher than the upper edge of the second lens 20, which is beneficial for improving a viewing experience.

In this embodiment of the present disclosure, the first quarter wave plate 40 and the first light-guiding surface 12 are separated by the air gap, so that the medium in contact with the first light-guiding surface 12 in a boundary area between the first area 121 and the second area 122 is always air. The refractive index difference between the air and the first lens 10 of the glass is large, which is conducive to ensuring that the image light undergoes total internal reflection in the first area 121, avoiding the destruction of total internal reflection conditions and light leakage caused by image light transmitting in the first area 121.

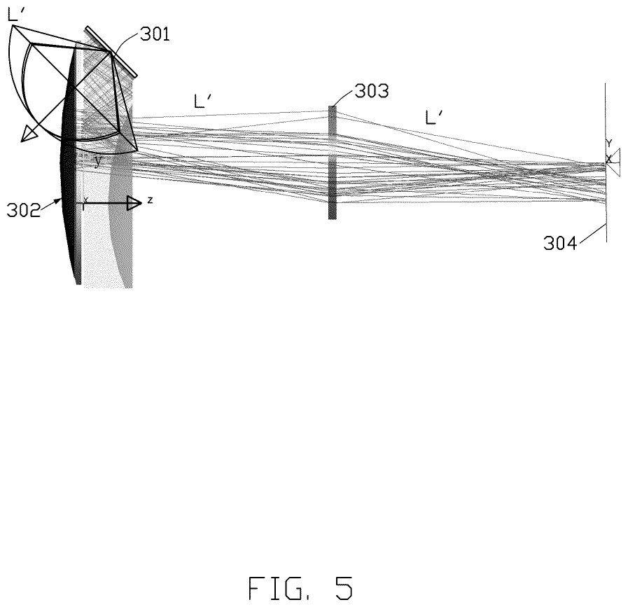

As shown in FIG. 5, a simulation software is used to simulate an effect of a optical system 302 on an image light L′ emitted from a display 301. The optical system 302 has a structure and function basically same with the optical system 1 as described above the embodiments of the present disclosure. An exit pupil position 303 is used to simulate a location of a human pupil, and a receiver 304 is used to simulate a human retina. A spatial Cartesian coordinate system is established with an optical axis of optical system 302 as the Z-axis, wherein the XY plane perpendicular to the Z-axis.

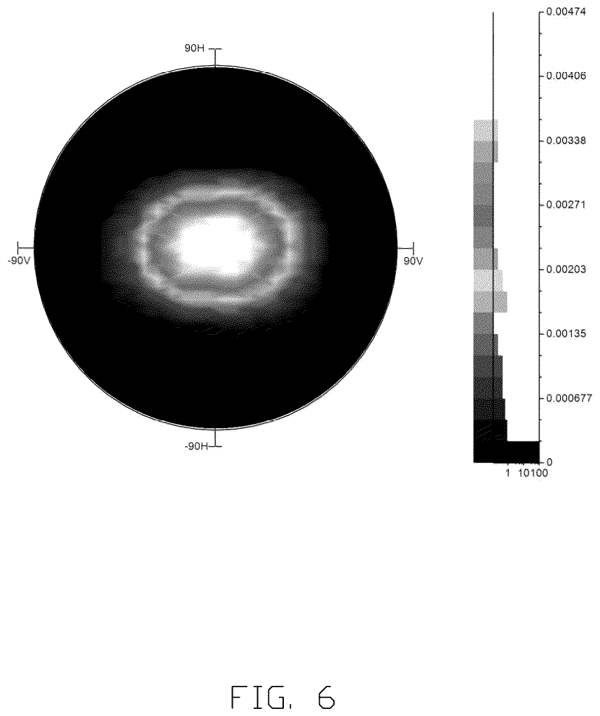

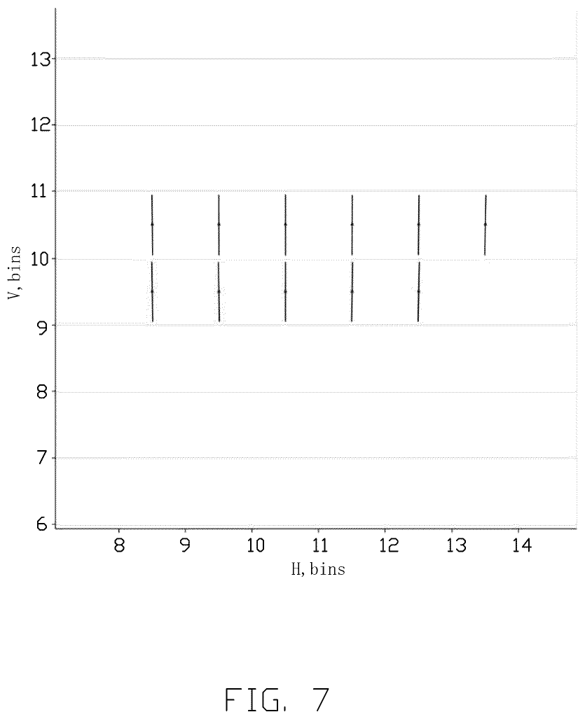

As shown in FIG. 6, a vertical axis represents an intensity of the image light. At a position of the receiver 304, an intensity distribution of the image light in the XY plane gradually weakens from the center towards a direction away from the center, and the intensity is relatively close at the same distance from the center. As shown in FIG. 7, a horizontal axis represents an interval distance H,bin (mm), and a vertical axis represents an interval distance V,bin (mm). According to FIG. 7, at the position of the receiver 304, the distribution of the ambient light is concentrated in the XY plane. Accordingly, the optical system 1 provided in the present embodiment can effectively guide the image light and the ambient light to the human eye, and can present clear AR images.

One ordinary skilled in the art should understand that the embodiments in the disclosure are used to illustrate the technical solution of the present disclosure and not to limit the present disclosure. The technical solution of the present disclosure can be modified or equivalent replaced without departing from the spirit and scope of the technical solution of the present disclosure.

1. An optical system comprising:
a first lens comprising a light incidence surface and a first light-guiding surface connected to each other, the first light-guiding surface comprising a first area and a second area connected to each other, the first area being configured for total internal reflection of image light from the light incidence surface, and the second area being configured to transmit the image light;
a second lens on a side of the first lens having the first light-guiding surface;
a reflective polarizer on a side of the first lens away from the second lens;
a first quarter wave plate between the first lens and the second lens; and
a selective reflector on a side of the second lens away from the first lens, the selective reflector being configured to reflect at least a portion of the image light towards the reflective polarizer.

2. The optical system according to claim 1, wherein orthographic projections of the second lens and the first quarter wave plate on the first light-guiding surface are within the second area.

3. The optical system according to claim 2, wherein optical axes of the first lens and the second lens are parallel to each other and non-coincide.

4. The optical system according to claim 2, wherein an air gap is between the quarter wave plate and the first light-guiding surface.

5. The optical system according to claim 1, wherein the first lens further comprises a second light-guiding surface and a bottom surface, the first light-guiding surface and the second light-guiding surface are respectively perpendicular to the optical axis of the first lens;
the light incidence surface, the first light-guiding surface, the bottom surface, and the second light-guiding surface are sequentially connected; and
the bottom surface is parallel to the optical axis of the first lens, and the light incidence surface and the optical axis of the first lens form a non-zero angle.

6. The optical system according to claim 5, wherein the first light-guiding surface and the light incidence surface are flat surfaces, and the non-zero angle between the first light-guiding surface and the light incidence surface is an acute angle.

7. The optical system according to claim 6, wherein the non-zero between the first light-guiding surface and the light incidence surface is greater than or equal to 10° and less than or equal to 70°.

8. The optical system according to claim 1, further comprises:
a first linear polarizer on a side of the selective reflector away from the second lens; and
a second quarter wave plate between the selective reflector and the first linear polarizer.

9. The optical system according to claim 1, further comprises a second linear polarizer on a side of the reflective polarizer away from the first lens.

10. The optical system according to claim 1, wherein the selective reflector is a beam splitter.

11. The optical system according to claim 1, wherein the first lens is fixed on the second lens.

12. The optical system according to claim 1, wherein the first lens is spaced apart from the second lens, and the first lens and/or the second lens can move along the optical axis of the first lens for focusing.

13. The optical system according to claim 1, wherein the first lens is a flat concave lens and the second lens is a flat convex lens.

14. A display device comprising:
a micro-display configured to emit image light; and
an optical system on a light path of the image light and being configured to modulate ambient light and the image light jointly to display AR images, the optical system comprising:
a first lens comprising a light incidence surface and a first light-guiding surface connected to each other, the first light-guiding surface comprising a first area and a second area connected to each other, the first area being configured for total internal reflection of image light from the light incidence surface, and the second area being configured to transmit the image light;
a second lens on a side of the first lens having the first light-guiding surface;
a reflective polarizer on a side of the first lens away from the second lens;
a first quarter wave plate between the first lens and the second lens; and
a selective reflector on a side of the second lens away from the first lens, the selective reflector being configured to reflect at least a portion of the image light towards the reflective polarizer.

15. The display device according to claim 14, wherein the micro-display comprises a display surface for emitting the image light, and the display surface is attached to the light incidence surface of the first lens.

16. The display device according to claim 14, wherein the image light emitted by the micro-display is in an S-polarization state.

17. The display device according to claim 14, wherein orthographic projections of the second lens and the first quarter wave plate on the first light-guiding surface are within the second area.

18. The display device according to claim 17, wherein optical axes of the first lens and the second lens are parallel to each other and non-coincide.

19. The display device according to claim 17, wherein an air gap is between the quarter wave plate and the first light-guiding surface.

20. The display device according to claim 14, further comprises:
a first linear polarizer on a side of the selective reflector away from the second lens; and
a second quarter wave plate between the selective reflector and the first linear polarizer.
